(19) United States
(12) Patent Application Publication
(10) Pub. No.: US 2025/0224627 A1
(43) Pub. Date: Jul. 10, 2025

(54) SEMICONDUCTOR DEVICE INCLUDING SPATIAL LIGHT MODULATOR AND METHOD FOR MANUFACTURING THE SAME

(71) Applicant: TAIWAN SEMICONDUCTOR MANUFACTURING COMPANY, LTD., Hsinchu (TW)

(72) Inventors: Yu-Wen WANG, Hsinchu (TW); Chang-Chih HUANG, Hsinchu (TW); Kuo-Chyuan TZENG, Hsinchu (TW)

(73) Assignee: TAIWAN SEMICONDUCTOR MANUFACTURING COMPANY, LTD., Hsinchu (TW)

(21) Appl. No.: 18/408,287

(22) Filed: Jan. 9, 2024

(51) Int. Cl. G02F 1/01

(52) U.S. Cl. CPC G02F 1/0147

(57) ABSTRACT

A semiconductor device includes a semiconductor substrate and a spatial light modulator. The spatial light modulator is disposed on the semiconductor substrate, and includes a plurality of pixels. Each of the pixels includes a heater portion, a phase change material portion, and a pair of spacers. The phase change material portion is disposed on the heater portion opposite to the semiconductor substrate. The spacers are disposed on the heater portion and laterally cover the phase change material portion.

### BACKGROUND

A spatial light modulator (SLM) is an optical device which can modulate optical characteristics (e.g., amplitude, phase, or polarization) of an incident light beam. The SLM has been widely applied in various fields, such as dynamic holography. Currently, in a manufacturing process flow of the SLM, some processes may slightly damage a structure of the SLM, which may adversely affect the device performance of the SLM. In order to avoid the structure of the SLM being damaged, the industry strives to improve the manufacturing process flow of the SLM.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are flow diagrams illustrating a method for manufacturing a semiconductor device in accordance with some embodiments.

FIGS. 2 to 16 are schematic views illustrating some intermediate stages of the method as depicted in FIGS. 1A and 1B in accordance with some embodiments.

FIGS. 17 and 18 are schematic views illustrating some intermediate stages of a method for manufacturing a semiconductor structure.

FIGS. 19 and 20 are schematic views illustrating some intermediate stages of a method for manufacturing a semiconductor structure.

FIGS. 21 and 22 are schematic views illustrating some intermediate stages of a method for manufacturing a semiconductor structure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “on,” “over,” “upper,” “topmost” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It should be noted that the element(s) or feature(s) are exaggeratedly shown in the figures for the purposed of convenient illustration and are not in scale.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some aspects ±10%, in some aspects ±5%, in some aspects ±2.5%, in some aspects ±1%, in some aspects ±0.5%, and in some aspects ±0.1% from the specified amount, as such variations are appropriate to perform the disclosed methods or employ the disclosed compositions.

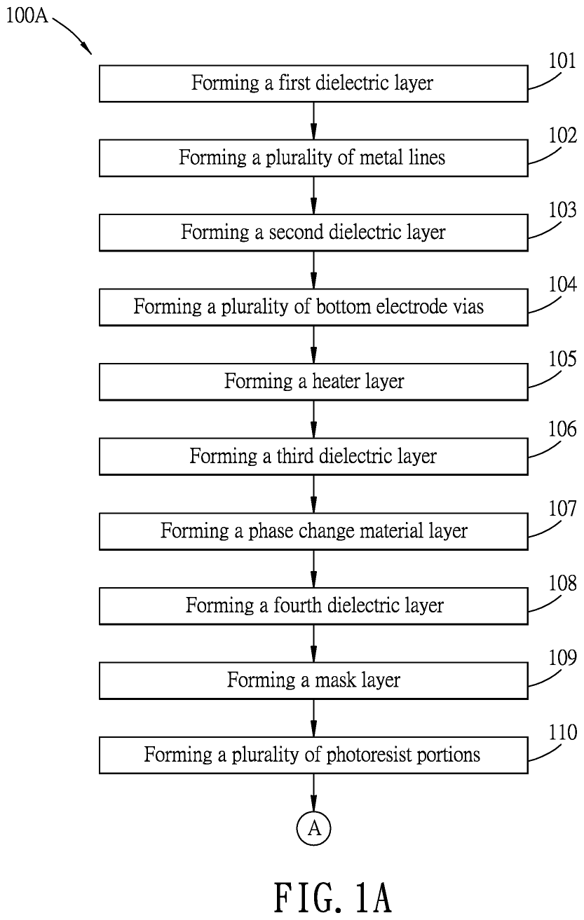

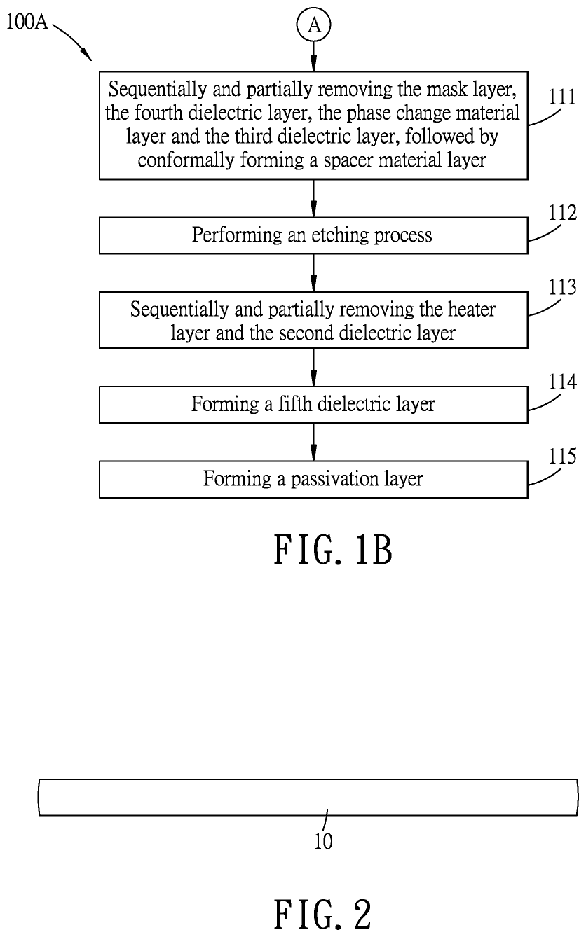

The present disclosure is directed to a semiconductor device including a spatial light modulator and a method for manufacturing the same. FIGS. 1A and 1B are flow diagrams illustrating a method 100A for manufacturing a semiconductor device 200A shown in FIG. 16 in accordance with some embodiments. FIGS. 2 to 15 illustrate schematic views of some intermediate stages of the method 100A. Some portions may be omitted in FIGS. 2 to 15 for the sake of brevity. Additional steps can be provided before, after or during the method 100A, and some of the steps described herein may be replaced by other steps or be eliminated.

Referring to FIG. 1A and the example illustrated in FIG. 2, the method 100A begins at step 101, where a first dielectric layer 10 is formed. In some embodiments, the first dielectric layer 10 is formed on a topmost dielectric layer of an interconnect structure (not shown) disposed on a semiconductor substrate (not shown). In some embodiments, the interconnect structure includes a plurality of contact vias (not shown) that are disposed in the topmost dielectric layer and that are spaced apart from each other. The first dielectric layer 10 may include, for example, but not limited to, silicon oxide, silicon nitride, silicon carbide, silicon oxynitride, silicon carbonitride, other suitable low dielectric constant material, or combinations thereof. Other suitable materials for the first dielectric layer 10 are within the contemplated scope of the present disclosure. The first dielectric layer 10 may be formed by a suitable deposition process, for example, but not limited to, chemical vapor deposition (CVD), physical vapor deposition (PVD), or other suitable deposition processes.

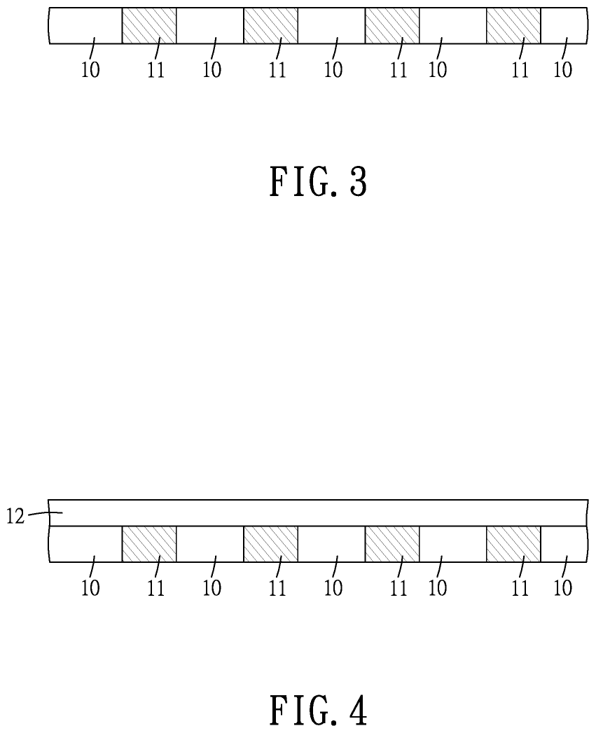

Referring to FIG. 1A and the example illustrated in FIG. 3, the method 100A then proceeds to step 102, where a plurality of metal lines 11 are formed in the first dielectric layer 10. Step 102 may include sub-steps: (i) patterning the first dielectric layer 10 to form a plurality of recesses (not shown), (ii) depositing a metallic material on the first dielectric layer 10 to fill the recesses, and (iii) removing excess of the metallic material on the first dielectric layer 10, so as to form the metal lines 11.

In sub-step (i), the first dielectric layer 10 may be patterned by photolithography, which includes an etching process. The photolithography may include, for example, but not limited to, coating a photoresist on the first dielectric layer 10, soft-baking the photoresist, exposing the photoresist through a photomask, post-exposure baking the photoresist, and developing the photoresist, followed by hard-baking the photoresist so as to form a patterned photoresist on the first dielectric layer 10. In the etching process, the first dielectric layer 10 may be etched by a suitable etching process, for example, but not limited to, dry etching, wet etching, a combination thereof, or other suitable etching processes, so as to form the recesses.

In sub-step (ii), the metallic material may be deposited by a suitable deposition process, for example, but not limited to, CVD, PVD, electroless plating, electroplating, or other suitable deposition processes.

In sub-step (iii), removal of excess of the metallic material on the first dielectric layer 10 may be performed by a suitable planarization process, for example, but not limited to, chemical mechanical polishing (CMP) or other suitable planarization processes. The metallic material for forming the metal lines 11 may include, for example, but not limited to, copper, aluminum, or a combination thereof. Other suitable materials for forming the metal lines 11 are within the contemplated scope of the present disclosure.

In some embodiments, one or more of the metal lines 11 are in contact with corresponding one(s) of the contact vias of the interconnect structure, respectively.

Referring to FIG. 1A and the example illustrated in FIG. 4, the method 100A then proceeds to step 103, where a second dielectric layer 12 is formed on the first dielectric layer 10 and the metal lines 11. The material and process for forming the second dielectric layer 12 may be the same as or similar to those for forming the first dielectric layer 10, and thus details thereof are omitted for the sake of brevity.

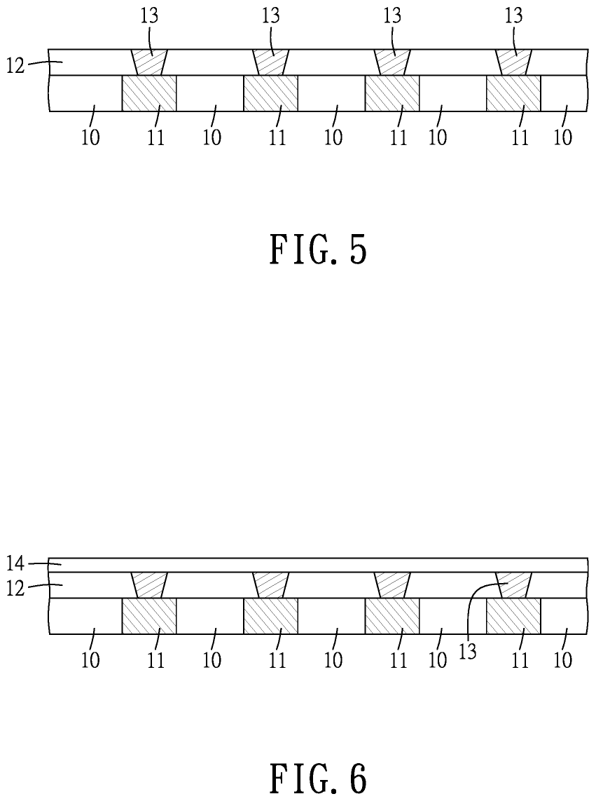

Referring to FIG. 1A and the example illustrated in FIG. 5, the method 100A then proceeds to step 104, where a plurality of bottom electrode vias (BEVAs) 13 are formed in the second dielectric layer 12. Step 104 may include sub-steps: (i) patterning the second dielectric layer 12 to form a plurality of openings (not shown), (ii) depositing an electrode material on the second dielectric layer 12 to fill the openings, and (iii) removing excess of the electrode material on the second dielectric layer 12, so as to form the BEVAs 13. The process (sub-steps (i) to (iii) of step 104) for forming the BEVAs 13 may be the same as or similar to that (sub-steps (i) to (iii) of step 102) for forming the metal lines 11, and thus details thereof are omitted for the sake of brevity. The electrode material for forming the BEVAs 13 may include, for example, but not limited to, tantalum, tantalum nitride, titanium, titanium nitride, tungsten, copper, aluminum copper, or combinations thereof. Other suitable materials for forming the BEVAs 13 are within the contemplated scope of the present disclosure.

Referring to FIG. 1A and the example illustrated in FIG. 6, the method 100A then proceeds to step 105, where a heater layer 14 is formed over the structure shown in FIG. 5. Step 105 may be performed by a suitable deposition process, for example, but not limited to, CVD, PVD, atomic layer deposition (ALD), or other suitable deposition processes. The heater layer 14 may be made of a material having a high melting point, that is, greater than about 1500 K. The material having a high melting point may include, for example, but not limited to, tungsten, tantalum nitride, titanium nitride, or combinations thereof. Other suitable materials for the heater layer 14 are within the contemplated scope of the present disclosure. In some embodiments, in this step, after formation of the heater layer 14, a top surface of the heater layer 14 may be planarized by a suitable planarization process (e.g., CMP or other suitable planarization processes). In some embodiments, the heater layer 14 and the BEVAs 13 may be made of the same material. In this case, the heater layer 14 may be formed integrally with the BEVAs 13.

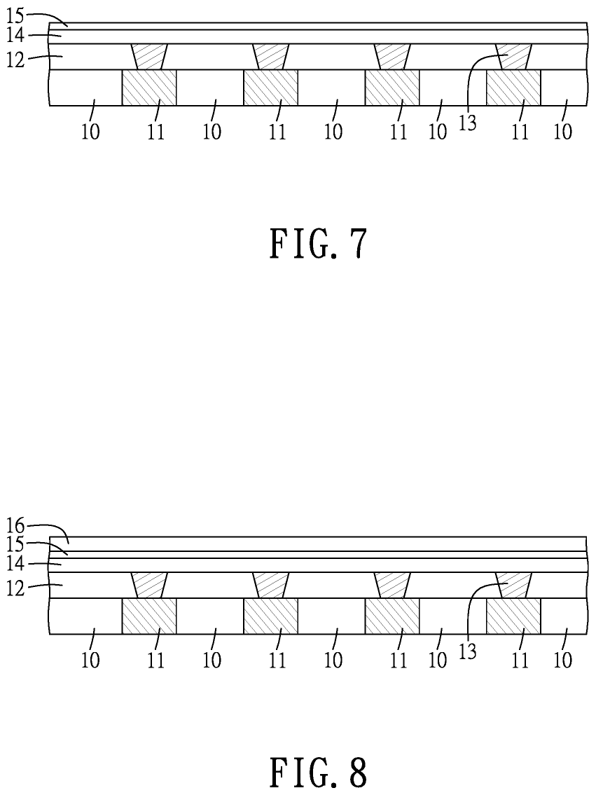

Referring to FIG. 1A and the example illustrated in FIG. 7, the method 100A then proceeds to step 106, where a third dielectric layer 15 is formed on the structure shown in FIG. 6. The material and process for forming the third dielectric layer 15 may be the same as or similar to those for forming the first dielectric layer 10, and thus details thereof are omitted for the sake of brevity. The third dielectric layer 15 may have a thickness ranging from about 50 Å to about 300 Å. In some embodiments, the third dielectric layer 15 is referred to as a lower dielectric layer.

Referring to FIG. 1A and the example illustrated in FIG. 8, the method 100A then proceeds to step 107, where a phase change material layer 16 is formed on the structure shown in FIG. 7. Step 107 may be performed by a suitable deposition process, for example, but not limited to, CVD, PVD, ALD, or other suitable deposition processes. The phase change material layer 16 may include, for example, but not limited to, germanium telluride, germanium-antimony-telluride, germanium-indium-antimony telluride, or combinations thereof. Other suitable materials for the phase change material layer 16 are within the contemplated scope of the present disclosure. The phase change material layer 16 may have a thickness ranging from about 50 Å to about 300 Å. In some embodiments, the phase change material layer 16 is light-transmissive.

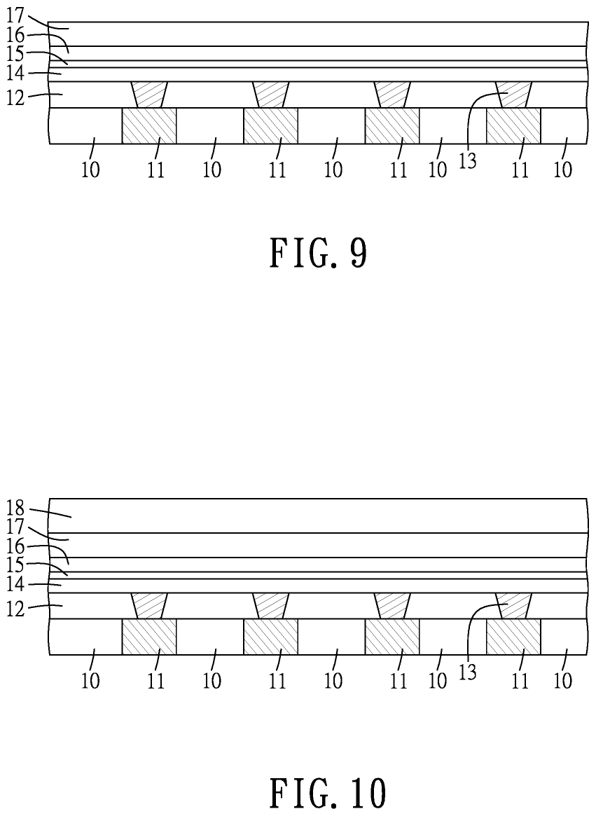

Referring to FIG. 1A and the example illustrated in FIG. 9, the method 100A then proceeds to step 108, where a fourth dielectric layer 17 is formed on the structure shown in FIG. 8. The material and process for forming the fourth dielectric layer 17 may be the same as or similar to those for forming the first dielectric layer 10, and thus details thereof are omitted for the sake of brevity. The fourth dielectric layer 17 may have a thickness ranging from about 50 Å to about 300 Å. In some embodiments, the fourth dielectric layer 17 is referred to as an upper dielectric layer. In some embodiments, the fourth dielectric layer 17 is light-transmissive.

In some embodiments, the third dielectric layer 15, the phase change material layer 16, and the fourth dielectric layer 17 are collectively referred to as a laminate.

Referring to FIG. 1A and the example illustrated in FIG. 10, the method 100A then proceeds to step 109, where a mask layer 18 is formed on the structure shown in FIG. 9. Step 109 may be performed by a suitable deposition process, for example, but not limited to, CVD, PVD, or other suitable deposition processes. The mask layer 18 may include, for example, but not limited to, silicon oxide, silicon nitride, silicon carbide, silicon oxynitride, silicon carbonitride, or combinations thereof. Other suitable materials for forming the mask layer 18 are within the contemplated scope of the present disclosure.

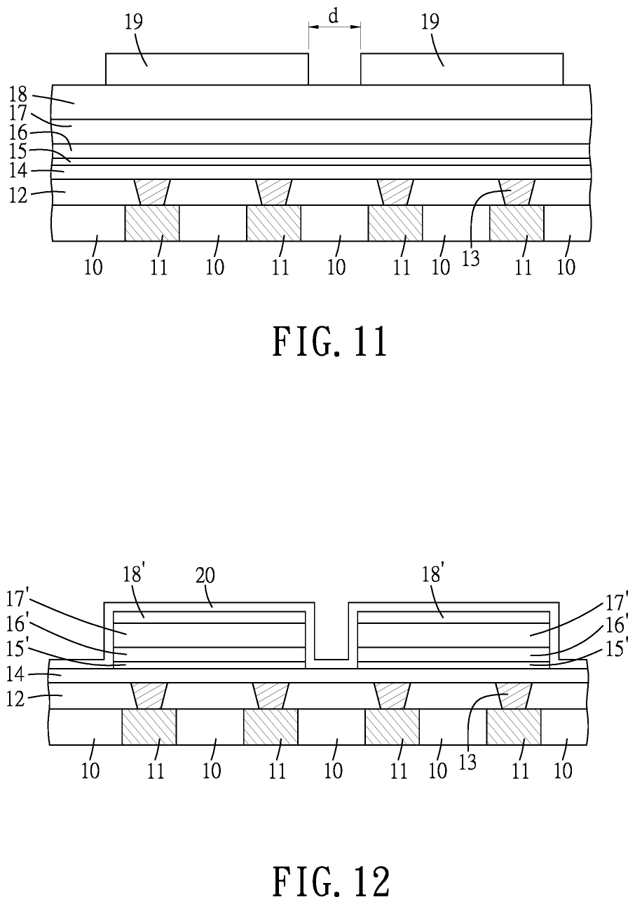

Referring to FIG. 1A and the example illustrated in FIG. 11, the method 100A then proceeds to step 110, where a plurality of photoresist portions 19 are formed on the structure shown in FIG. 10. Step 110 may be performed by photolithography (as described in step 102) without the etching process to form a patterned photoresist layer with the photoresist portions 19. The photoresist portions 19 may be spaced apart from one another. In some embodiments, two adjacent ones of the photoresist portions 19 are separated from each other by a distance (d) ranging from about 30 nm to about 100 nm. In some embodiments, the distance (d) may be referred to as a photo minimal space. When the distance (d) is greater than about 100 nm, an effective pixel size of phase change material portions 16′ (which will be described hereinafter) may be reduced.

Referring to FIG. 1B and the example illustrated in FIG. 12, the method 100A then proceeds to step 111, where the mask layer 18, the fourth dielectric layer 17, the phase change material layer 16 and the third dielectric layer 15 are sequentially and partially removed, followed by conformally forming a spacer material layer 20. In this step, multiple etching processes may be sequentially performed to partially remove the mask layer 18, the fourth dielectric layer 17, the phase change material layer 16 and the third dielectric layer 15. In some embodiments, each of the etching processes may be a dry etching process (e.g., anisotropically etching process) or other suitable etching processes. After the etching processes, the mask layer 18 is formed into a plurality of mask portions 18′, the fourth dielectric layer 17 is formed into a plurality of fourth dielectric portions 17′ (may be referred to as upper dielectric portions 17′), the phase change material layer 16 is formed into a plurality of phase change material portions 16′, and the third dielectric layer 15 is formed into a plurality of third dielectric portions 15′ (may be referred to as lower dielectric portions 15′). In some embodiments, after the etching processes, the laminate is formed into a plurality of laminate portions, and each of the laminate portions includes a corresponding one of the third dielectric portions 15′, a corresponding one of the phase change material portions 16′ and a corresponding one of the fourth dielectric portions 17′. The material and process for forming the spacer material layer 20 may be the same as or similar to those for forming the first dielectric layer 10, and thus details thereof are omitted for the sake of brevity. The spacer material layer 20 covers a portion of an upper surface of the heater layer 14, upper and side surfaces of each of the mask portions 18′, and side surfaces of each of the laminate portions. In some embodiments, in this step, the third dielectric layer 15 may not be partially removed. In this case, each of the laminate portions includes a corresponding one of the phase change material portions 16′ and a corresponding one of the fourth dielectric portions 17′, and the spacer material layer 20 covers a portion of an upper surface of the third dielectric layer 15, upper and side surfaces of each of the mask portions 18′, and side surfaces of each of the laminate portions.

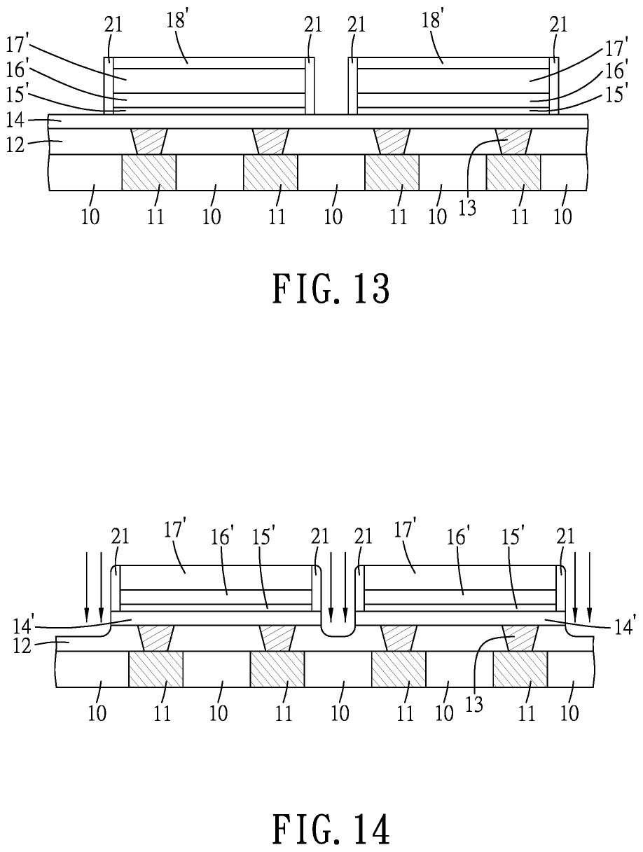

Referring to FIG. 1B and the example illustrated in FIG. 13, the method 100A then proceeds to step 112, where an etching process is performed on the structure shown in FIG. 12, so as to form the spacer material layer 20 into a plurality of pairs of spacers 21. In this step, the etching process may be a dry etching process (e.g., anisotropically etching process) or other suitable etching processes. After this step, each pair of the spacers 21 laterally covers a corresponding one of the laminate portions.

Referring to FIG. 1B and the example illustrated in FIG. 14, the method 100A then proceeds to step 113, where the heater layer 14 and the second dielectric layer 12 are sequentially and partially removed. In this step, the etching processes may be conducted twice for partially etching the heater layer 14 and the second dielectric layer 12, respectively. Each of the etching processes may be a dry etching process (e.g., anisotropically etching process) or other suitable etching processes. In some embodiments, an etchant used in the etching process of the heater layer 14 may include, for example, but not limited to, fluorine-based gas, chlorine-based gas, or other suitable etchant gases. After this step, the heater layer 14 is formed into a plurality of heater portions 14′. In some embodiments, after this step, the mask portions 18′ (see FIG. 13) are fully removed and the spacers 21 are partially removed. In some embodiments, an outer edge of each of the spacers 21 is aligned with an outer edge of a corresponding one of the heater portions 14′.

In some embodiments, steps 112 and 113 may be performed in one continuous operation.

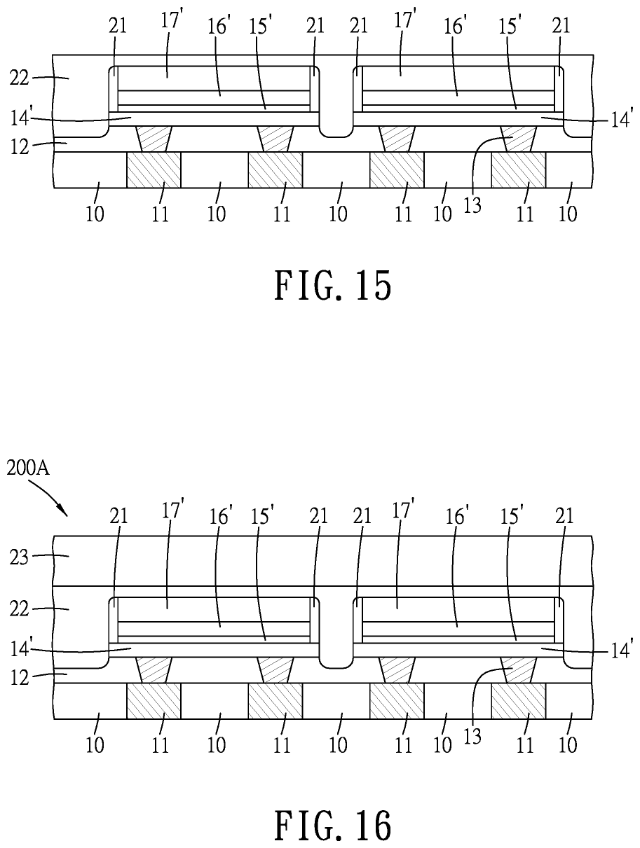

Referring to FIG. 1B and the example illustrated in FIG. 15, the method 100A then proceeds to step 114, where a fifth dielectric layer 22 is formed on the structure shown in FIG. 14. The material and process for forming the fifth dielectric layer 22 may be the same as or similar to those for forming the first dielectric layer 10, and thus details thereof are omitted for the sake of brevity.

Referring to FIG. 1B and the example illustrated in FIG. 16, the method 100A then proceeds to step 115, where a passivation layer 23 is formed on the structure shown in FIG. 15. Step 115 may be performed by a suitable deposition process, for example, but not limited to, CVD, PVD, or other suitable deposition processes. The passivation layer 23 may include, for example, but not limited to, nitride-based material (e.g., silicon nitride), oxide-based material (e.g., silicon oxide), or other suitable materials. Other suitable materials for the passivation layer 23 are within the contemplated scope of the present disclosure. After this step, the semiconductor device 200A is obtained. In some embodiments, the semiconductor device 200A includes an optical device, for example, but not limited to, a spatial light modulator (SLM), which includes a plurality of pixels. Each of the pixels includes a stack of one of the heater portions 14′, a corresponding one of the third dielectric portions 15′ disposed on the one of the heater portions 14′, a corresponding one of the phase change material portions 16′ disposed on the corresponding one of the third dielectric portions 15′ opposite to the one of the heater portions 14′, a corresponding one of the fourth dielectric portions 17′ disposed on the corresponding one of the phase change material portions 16′ opposite to the corresponding one of the third dielectric portions 15′, and a corresponding one of the pairs of the spacers 21 disposed on the one of the heater portions 14′ and laterally covering the corresponding one of the third dielectric portions 15′, the corresponding one of the phase change material portions 16′, and the corresponding one of the fourth dielectric portions 17′. In some embodiments, the corresponding one of the pairs of the spacers 21 is disposed on the corresponding one of the third dielectric portions 15′ opposite to the one of the heater portions 14′ and laterally covers the corresponding one of the phase change material portions 16′ and the corresponding one of the fourth dielectric portions 17′.

In some embodiments, when a current is applied to one of the heater portions 14′ of the semiconductor device 200A through corresponding one(s) of the BEVAs 13, the one of the heater portions 14′ may generate a heat energy, and the heat energy may be transferred to a corresponding one of the phase change material portions 16′ through a corresponding one of the third dielectric portions 15′. When the thickness of the third dielectric portions 15′ (i.e., the thickness of the third dielectric layer 15) is greater than about 300 Å, the heat energy generated from the one of the heater portions 14′ may not be efficiently transferred to the corresponding one of the phase change material portions 16′. In some embodiments, when one of the phase change material portions 16′ is heated (e.g., absorbing the heat energy generated from a corresponding one of the heater portions 14′), the one of the phase change material portions 16′ may have a phase transition, i.e., transformed from a first phase to a second phase. In some embodiments, the first phase may be one of an amorphous phase and a crystalline phase, and the second phase may be the other one of the amorphous phase and the crystalline phase. In some embodiments, when one of the phase change material portions 16′ is heated, it is transformed to the amorphous phase. In contrast, when one of the phase change material portions 16′ is not heated, it is transformed to the crystalline phase, such that the special light modulator will produce a holographic image. When the thickness of the phase change material portions 16′ (i.e., the thickness of the phase change material layer 16) is smaller than about 50 Å or greater than about 300 Å, the phase change material portions 16′ may not exhibit a difference in reflection intensity of light between the first phase and the second phase.

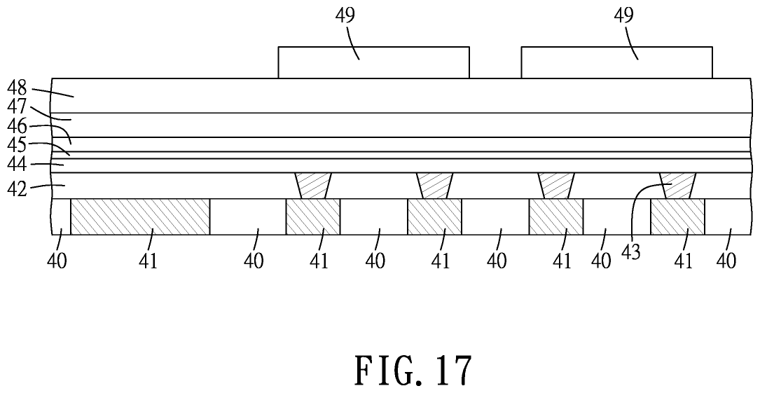

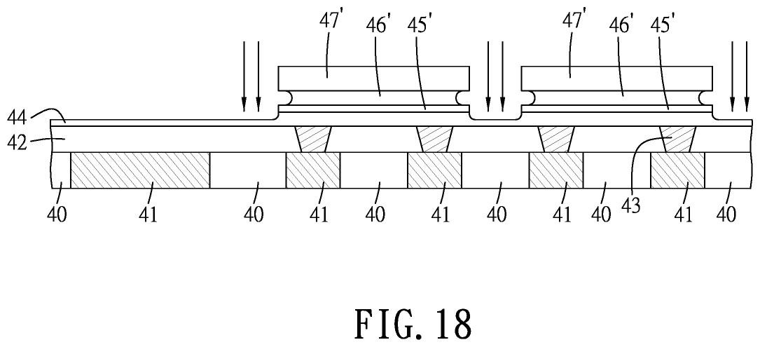

FIGS. 17 and 18 illustrate some intermediate steps of a method for manufacturing a semiconductor device (not shown). The semiconductor device is generally similar to the semiconductor device 200A. The intermediate steps shown in FIGS. 17 and 18 are generally similar to steps 110 and 113 of the method 100A, respectively.

As shown in FIG. 17, a semiconductor structure is provided. The semiconductor structure includes a first dielectric layer 40, a plurality of metal lines 41, a second dielectric layer 42, a plurality of bottom electrode vias 43, a heater layer 44, a third dielectric layer 45, a phase change material layer 46, a fourth dielectric layer 47, a mask layer 48, and a plurality of photoresist portions 49. The metal lines 41 are formed in the first dielectric layer 40 and are spaced apart from one another. The second dielectric layer 42 is formed on the first dielectric layer 40 and on the metal lines 41. The bottom electrode vias 43 are formed in the second dielectric layer 42 and are spaced apart from one another. The heater layer 44 is formed on the second dielectric layer 42 opposite to the first dielectric layer 40. The third dielectric layer 45 is formed on the heater layer 44 opposite to the second dielectric layer 42. The phase change material layer 46 is formed on the third dielectric layer 45 opposite to the heater layer 44. The fourth dielectric layer 47 is formed on the phase change material layer 46 opposite to the third dielectric layer 45. The mask layer 48 is formed on the fourth dielectric layer 47 opposite to the phase change material layer 46. The photoresist portions 49 are formed on the mask layer 48 opposite to the fourth dielectric layer 47 and are spaced apart from one another.

As shown in FIG. 18, multiple etching processes (e.g., dry etching) are sequentially performed on the structure shown in FIG. 17 to remove the mask layer 48, a portion of the fourth dielectric layer 47, a portion of the phase change material layer 46, a portion of the third dielectric layer 45, and a portion of the heater layer 44, so as to form the fourth dielectric layer 47 into a plurality of fourth dielectric portions 47′, to form the phase change material layer 46 into a plurality of phase change material portions 46′, and to form the third dielectric layer 45 into a plurality of third dielectric portions 45′.

In the etching process of the heater layer 44, a sidewall of each of the phase change material portions 46′ may be indented because the phase change material portions 46′ may react with an etchant (e.g., a fluorine-based gas or a chlorine-based gas) used in the etching process. In this case, the effective pixel size of the phase change material portions 46′ may be reduced. In steps 110 to 113 of the method 100A shown in FIGS. 11 to 14, since each pair of the spacers 21 is formed to laterally cover sidewalls of a corresponding one of the phase change material portions 16′ (i.e., step 112), the phase change material portions 16′ may be prevented from being reacted with the etchant during the etching process of the heater layer 14 (i.e., step 113). Therefore, the effective pixel size of the phase change material portions 16′ may not be adversely affected, which is conducive to improving the device performance and manufacturing quality of the semiconductor device 200A.

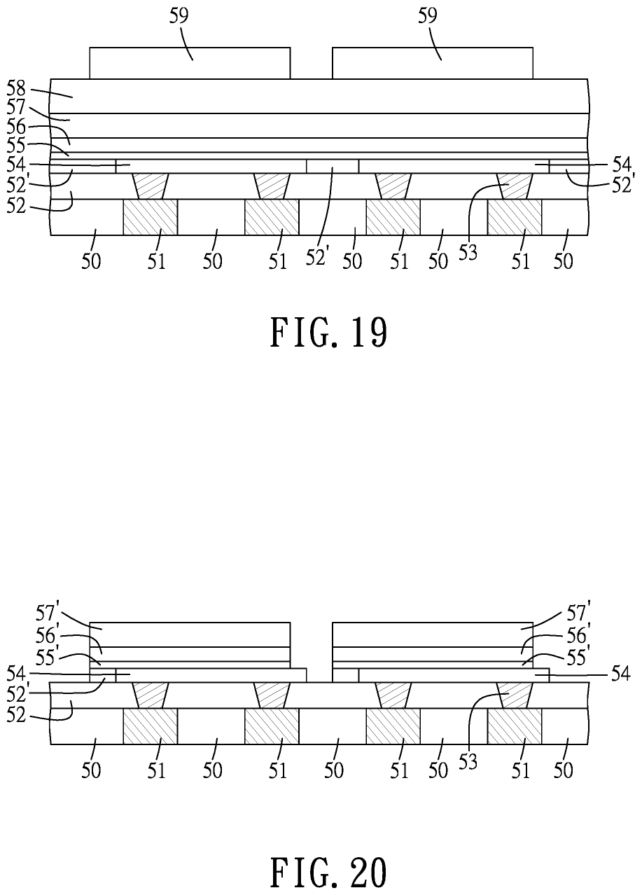

FIGS. 19 and 20 illustrate some intermediate steps of a method for manufacturing a semiconductor device (not shown). The semiconductor device is generally similar to the semiconductor device 200A. The intermediate steps shown in FIGS. 19 and 20 are respectively generally similar to steps 110 and 113 of the method 100A.

As shown in FIG. 19, a semiconductor structure is provided. The semiconductor structure includes a first dielectric layer 50, a plurality of metal lines 51, a second dielectric layer 52, a plurality of dielectric material portions 52′, a plurality of bottom electrode vias 53, a plurality of heater portions 54, a third dielectric layer 55, a phase change material layer 56, a fourth dielectric layer 57, a mask layer 58, and a plurality of photoresist portions 59. The metal lines 51 are formed in the first dielectric layer 50 and are spaced apart from one another. The second dielectric layer 52 is formed on the first dielectric layer 50 and on the metal lines 51. The bottom electrode vias 53 are formed in the second dielectric layer 52 and are spaced apart from one another. Each of the heater portions 54 is formed on corresponding ones of the bottom electrode vias 53. Formation of the heater portions 54 may involve depositing a heater layer (not shown) on the second dielectric layer 52 and the bottom electrode vias 53, followed by patterning the heater layer, so as to obtain the heater portions 54. After formation of the heater portions 54, a dielectric material layer (not shown) is formed on the second dielectric layer 52 and the heater portions 54, and then a planarization process (e.g., CMP or other suitable planarization processes) is performed to remove an excess portion of the dielectric material layer until the heater portions 54 are exposed. In some embodiments, the dielectric material layer and the second dielectric layer 52 may be made of the same material. After the planarization process, the dielectric material layer is formed into the dielectric material portions 52′. The third dielectric layer 55 is formed on the dielectric material portions 52′ and the heater portions 54. The phase change material layer 56 is formed on the third dielectric layer 55 opposite to the second dielectric layer 52. The fourth dielectric layer 57 is formed on the phase change material layer 56 opposite to the third dielectric layer 55. The mask layer 58 is formed on the fourth dielectric layer 57 opposite to the phase change material layer 56. The photoresist portions 59 are formed on the mask layer 58 opposite to the fourth dielectric layer 57 and are spaced apart from one another.

As shown in FIG. 20, multiple etching processes (e.g., dry etching or other suitable etching processes) are sequentially performed on the structure shown in FIG. 19 to remove the mask layer 58, a portion of the fourth dielectric layer 57, a portion of the phase change material layer 56, a portion of the third dielectric layer 55, and a part of each of the dielectric material portions 52′, so as to form the fourth dielectric layer 57 into a plurality of fourth dielectric portions 57′, to form the phase change material layer 56 into a plurality of phase change material portions 56′, and to form the third dielectric layer 55 into a plurality of third dielectric portions 55′. A size of each of the phase change material portions 56′ corresponds to a size of a corresponding one of the photoresist portions 59 (see FIG. 19).

In this case, each of the phase change material portions 56′ may have an overlay (OVL) shift with respect to a corresponding one of the heater portions 54 because a projection of each of the phase change material portions 56′ on an imaginary plane (e.g., the second dielectric layer 52) does not fully overlap with a projection of a corresponding one of the heater portions 54 on the imaginary plane. That is, each of the phase change material portions 56′ is not aligned with a corresponding one of the heater portions 54. The OVL shift of the phase change material portions 56′ may be caused by a process variation during formation of the photoresist portions 59. As such, each of the phase change material portions 56′ may not entirely absorb a heat energy generated from a corresponding one of the heater portions 54 when a current is applied to the corresponding one of the heater portions 54 of the semiconductor device, and may not have a complete phase transition.

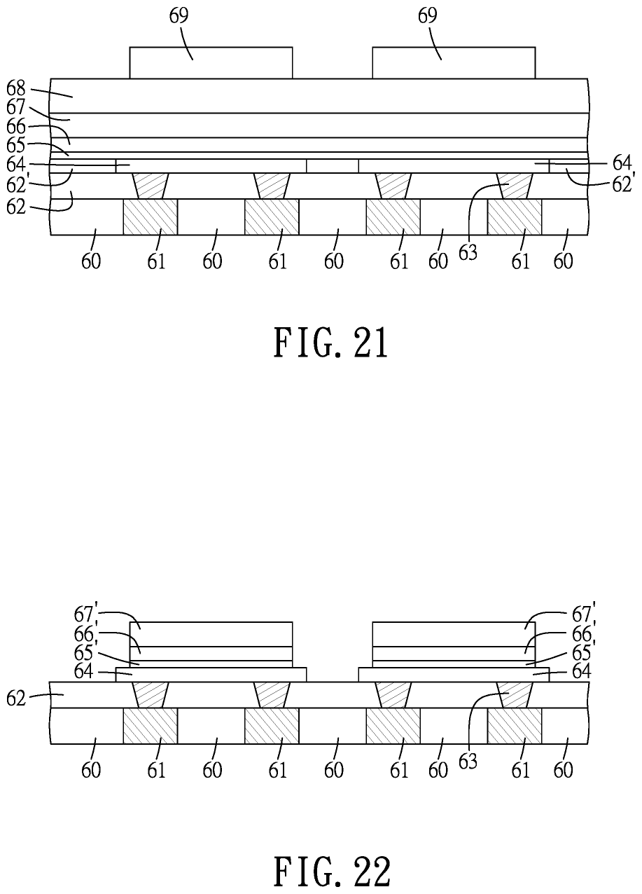

FIGS. 21 and 22 illustrate some intermediate steps of a method for manufacturing a semiconductor device (not shown). The intermediate steps shown in FIGS. 21 and 22 are respectively generally similar to the intermediate steps shown in FIGS. 19 and 20.

As shown in FIG. 21, a semiconductor structure is provided, and is generally similar to the structure shown in FIG. 19, except that, a projection of each of photoresist portions 69 on an imaginary plane (e.g., a second dielectric layer 62) falls within a projection of a corresponding one of heater portions 64 on the imaginary plane. The semiconductor structure includes a first dielectric layer 60, a plurality of metal lines 61, the second dielectric layer 62, a plurality of dielectric material portions 62′, a plurality of bottom electrode vias 63, the heater portions 64, a third dielectric layer 65, a phase change material layer 66, a fourth dielectric layer 67, a mask layer 68, and the photoresist portions 69. The metal lines 61 are formed in the first dielectric layer 60 and are spaced apart from one another. The second dielectric layer 62 is formed on the first dielectric layer 60 and on the metal lines 61. The bottom electrode vias 63 are formed in the second dielectric layer 62 and are spaced apart from one another. Each of the heater portions 64 is formed on corresponding ones of the bottom electrode vias 63. Formation of the heater portions 64 may involve depositing a heater layer (not shown) on the second dielectric layer 62 and the bottom electrode vias 63, followed by patterning the heater layer, so as to form the heater portions 64. After formation of the heater portions 64, a dielectric material layer (not shown) is formed on the second dielectric layer 62 and the heater portions 64, and then a planarization process (e.g., CMP or other suitable planarization processes) is performed to remove an excess portion of the dielectric material layer until the heater portions 64 are exposed. In some embodiments, the dielectric material layer and the second dielectric layer 62 may be made of the same material. After the planarization process, the dielectric material layer is formed into a plurality of dielectric material portions 62′. The third dielectric layer 65 is formed on the dielectric material portions 62′ and the heater portions 64. The phase change material layer 66 is formed on the third dielectric layer 65 opposite to the second dielectric layer 62. The fourth dielectric layer 67 is formed on the phase change material layer 66 opposite to the third dielectric layer 65. The mask layer 68 is formed on the fourth dielectric layer 67 opposite to the phase change material layer 66. The photoresist portions 69 are formed on the mask layer 68 opposite to the fourth dielectric layer 67 and are spaced apart from one another.

As shown in FIG. 22, multiple etching processes (e.g., dry etching or other suitable etching processes) are sequentially performed on the structure shown in FIG. 21 to remove the mask layer 68, a portion of the fourth dielectric layer 67, a portion of the phase change material layer 66, and a portion of the third dielectric layer 65, and a part of the dielectric material portions 62′, so as to form the fourth dielectric layer 67 into a plurality of fourth dielectric portions 67′, to form the phase change material layer 66 into a plurality of phase change material portions 66′, and to form the third dielectric layer 65 into a plurality of third dielectric portions 65′. In this case, a projection of each of the phase change material portions 66′ on an imaginary plane (e.g., the second dielectric layer 62) falls within a projection of a corresponding one of the heater portions 64 on the imaginary plane, so that each of the phase change material portions 66′ does not have an OVL shift with respect to a corresponding one of the heater portions 64, and may entirely absorb a heat energy generated from the corresponding one of the heater portions 64 to have a complete phase transition. Nevertheless, in this case, a size of the phase change material portions 66′ may be shrunk to avoid the OVL shift, resulting in a reduced effective pixel size thereof.

In the method 100A for manufacturing the semiconductor device 200A, because the heater portions 14′ are formed after formation of the phase change material portions 16′ (step 113), which are laterally covered by the spacers 21, a size of each of the phase change material portions 16′ mainly depends on a size of a corresponding one of the photoresist portions 19, and may not be shrunk to avoid an OVL shift with respect to a corresponding one of the heater portions 14′, so that the effective pixel size of each of the phase change material portions 16′ may be maximized.

In this disclosure, by having a plurality of pairs of spacers that respectively and laterally cover a plurality of phase change material portions in a semiconductor device, the phase change material portions may not be damaged or adversely affected in a subsequent etching process, which is conducive to maximizing the effective pixel size of the phase change material portions and further improving the device performance and manufacturing quality of the semiconductor device.

In accordance with some embodiments of the present disclosure, a semiconductor device includes a semiconductor substrate and a spatial light modulator. The spatial light modulator is disposed on the semiconductor substrate, and includes a plurality of pixels. Each of the pixels includes a heater portion, a phase change material portion, and a pair of spacers. The phase change material portion is disposed on the heater portion opposite to the semiconductor substrate. The spacers are disposed on the heater portion and laterally cover the phase change material portion.

In accordance with some embodiments of the present disclosure, each of the pixels further includes a lower dielectric portion and an upper dielectric portion. The lower dielectric portion is disposed between the heater portion and the phase change material portion. The upper dielectric portion is disposed on the phase change material portion opposite to the lower dielectric portion and is laterally covered by the spacers.

In accordance with some embodiments of the present disclosure, the lower dielectric portion is laterally covered by the spacers.

In accordance with some embodiments of the present disclosure, the spacers are disposed on the lower dielectric portion opposite to the heater portion.

In accordance with some embodiments of the present disclosure, an outer edge of each of the spacers is aligned with an outer edge of the heater portion.

In accordance with some embodiments of the present disclosure, the heater portion is made of a metal material having a melting point that is greater than 1500 K.

In accordance with some embodiments of the present disclosure, a projection of the phase change material portion on the semiconductor substrate falls within a projection of the heater portion on the semiconductor substrate.

In accordance with some embodiments of the present disclosure, a method for manufacturing a semiconductor device includes: forming a heater layer on a semiconductor substrate; forming a laminate on the heater layer opposite to the semiconductor substrate, the laminate including a phase change material layer; patterning the laminate to form a plurality of laminate portions spaced apart from each other, each of the laminate portions including a phase change material portion formed by patterning the phase change material layer; forming a spacer material layer to conformally cover the laminate portions; and removing portions of the spacer material layer to form a plurality of pairs of spacers, each pair of the spacers laterally covering a corresponding one of the laminate portions.

In accordance with some embodiments of the present disclosure, the method for manufacturing a semiconductor device further includes, patterning the heater layer to form a plurality of heater portions disposed below the laminate portions, respectively, such that a projection of the phase change material portion of each of the laminate portions on the semiconductor substrate falls within a projection of a corresponding one of the heater portions on the semiconductor substrate.

In accordance with some embodiments of the present disclosure, the heater layer is patterned by dry etching.

In accordance with some embodiments of the present disclosure, the dry etching is performed using an etchant including a fluorine-based gas, a chlorine-based gas, or a combination thereof.

In accordance with some embodiments of the present disclosure, in formation of the laminate, an upper dielectric layer is formed on the phase change material layer opposite to the heater layer; and in formation of the laminate portions, each of the laminate portions further includes an upper dielectric portion which is formed by patterning the upper dielectric layer and which is disposed on the phase change material portion opposite to a corresponding one of the heater portions.

In accordance with some embodiments of the present disclosure, the method for manufacturing a semiconductor device further includes, forming a lower dielectric layer between the laminate portions and the heater layer, such that each pair of the spacers are disposed on the lower dielectric layer to laterally cover the phase change material portion and the upper dielectric portion of a corresponding one of the laminate portions; and before formation of the heater portions, patterning the lower dielectric layer to form a plurality of lower dielectric portions, such that each pair of the spacers are disposed on a corresponding one of the lower dielectric portions opposite to a corresponding one of the heater portions.

In accordance with some embodiments of the present disclosure, in formation of the laminate, a lower dielectric layer is formed between the phase change material layer and the heater layer, and an upper dielectric layer is formed on the phase change material layer opposite to the lower dielectric layer; and in formation of the laminate portions, each of the laminate portions further includes a lower dielectric portion and an upper dielectric portion. The lower dielectric portion is formed by patterning the lower dielectric layer and is disposed between the phase change material portion and a corresponding one of the heater portions. An upper dielectric portion is formed by patterning the upper dielectric layer and is disposed on the phase change material portion opposite to the lower dielectric portion.

In accordance with some embodiments of the present disclosure, the method for manufacturing a semiconductor device further includes, before formation of the heater layer, forming a plurality of bottom electrode vias on the semiconductor substrate, such that at least one of the bottom electrode vias is connected to a corresponding one of the heater portions.

In accordance with some embodiments of the present disclosure, a method for manufacturing a semiconductor device includes: forming a heater layer on a semiconductor substrate; forming a phase change material layer on the heater layer opposite to the semiconductor substrate; forming an upper dielectric layer on the phase change material layer opposite to the heater layer; patterning the upper dielectric layer and the phase change material layer to form a plurality of upper dielectric portions and a plurality of phase change material portions disposed below the upper dielectric portions, respectively; forming a spacer material layer to conformally cover the upper dielectric portions and the phase change material portions; removing portions of the spacer material layer to form a plurality of pairs of spacers, each of the pairs of the spacers laterally covering a corresponding one of the upper dielectric portions and a corresponding one of the phase change material portions; and patterning the heater layer to form a plurality of heater portions, each of the heater portions being disposed below a corresponding one of the phase change material portions opposite to a corresponding one of the upper dielectric portions.

In accordance with some embodiments of the present disclosure, the method for manufacturing a semiconductor device further includes, before formation of the phase change material layer, forming a lower dielectric layer on the heater layer such that the lower dielectric layer is disposed between the heater layer and the phase change material layer.

In accordance with some embodiments of the present disclosure, the method for manufacturing a semiconductor device further includes, after formation of the spacers and before formation of the heater portions, patterning the lower dielectric layer to form a plurality of lower dielectric portions, such that each of the pairs of the spacers is disposed on a corresponding one of the lower dielectric portions opposite to a corresponding one of the heater portions.

In accordance with some embodiments of the present disclosure, the method for manufacturing a semiconductor device further includes, before formation of the spacers, patterning the lower dielectric layer to form a plurality of lower dielectric portions, such that each of the pairs of the spacers is disposed on a corresponding one of the heater portions and further laterally covers a corresponding one of the lower dielectric portions.

In accordance with some embodiments of the present disclosure, the method for manufacturing a semiconductor device further includes, before formation of the heater layer, forming a plurality of bottom electrode vias on the semiconductor substrate, such that at least one of the bottom electrode vias is connected to a corresponding one of the heater portions.

The foregoing outlines features of several embodiments so that those skilled in the art may better understand the aspects of the present disclosure. Those skilled in the art should appreciate that they may readily use the present disclosure as a basis for designing or modifying other processes or structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device, comprising:
a semiconductor substrate; and
a spatial light modulator disposed on the semiconductor substrate, and including a plurality of pixels, each of the pixels including
a heater portion,
a phase change material portion disposed on the heater portion opposite to the semiconductor substrate, and
a pair of spacers disposed on the heater portion and laterally covering the phase change material portion.

2. The semiconductor device as claimed in claim 1, wherein each of the pixels further includes:
a lower dielectric portion disposed between the heater portion and the phase change material portion; and
an upper dielectric portion disposed on the phase change material portion opposite to the lower dielectric portion and laterally covered by the spacers.

3. The semiconductor device as claimed in claim 2, wherein the lower dielectric portion is laterally covered by the spacers.

4. The semiconductor device as claimed in claim 2, wherein the spacers are disposed on the lower dielectric portion opposite to the heater portion.

5. The semiconductor device as claimed in claim 1, wherein an outer edge of each of the spacers is aligned with an outer edge of the heater portion.

6. The semiconductor device as claimed in claim 1, wherein the heater portion is made of a metal material having a melting point that is greater than 1500 K.

7. The semiconductor device as claimed in claim 1, wherein a projection of the phase change material portion on the semiconductor substrate falls within a projection of the heater portion on the semiconductor substrate.

8. A method for manufacturing a semiconductor device, comprising:
forming a heater layer on a semiconductor substrate;
forming a laminate on the heater layer opposite to the semiconductor substrate, the laminate including a phase change material layer;
patterning the laminate to form a plurality of laminate portions spaced apart from each other, each of the laminate portions including a phase change material portion formed by patterning the phase change material layer;
forming a spacer material layer to conformally cover the laminate portions; and
removing portions of the spacer material layer to form a plurality of pairs of spacers, each pair of the spacers laterally covering a corresponding one of the laminate portions.

9. The method as claimed in claim 8, further comprising: patterning the heater layer to form a plurality of heater portions disposed below the laminate portions, respectively, such that a projection of the phase change material portion of each of the laminate portions on the semiconductor substrate falls within a projection of a corresponding one of the heater portions on the semiconductor substrate.

10. The method as claimed in claim 9, wherein the heater layer is patterned by dry etching.

11. The method as claimed in claim 10, wherein the dry etching is performed using an etchant including a fluorine-based gas, a chlorine-based gas, or a combination thereof.

12. The method as claimed in claim 9, wherein
in formation of the laminate, an upper dielectric layer is formed on the phase change material layer opposite to the heater layer; and
in formation of the laminate portions, each of the laminate portions further includes an upper dielectric portion which is formed by patterning the upper dielectric layer and which is disposed on the phase change material portion opposite to a corresponding one of the heater portions.

13. The method as claimed in claim 12, further comprising:
forming a lower dielectric layer between the laminate portions and the heater layer, such that each pair of the spacers are disposed on the lower dielectric layer to laterally cover the phase change material portion and the upper dielectric portion of a corresponding one of the laminate portions; and
before formation of the heater portions, patterning the lower dielectric layer to form a plurality of lower dielectric portions, such that each pair of the spacers are disposed on a corresponding one of the lower dielectric portions opposite to a corresponding one of the heater portions.

14. The method as claimed in claim 9, wherein
in formation of the laminate, a lower dielectric layer is formed between the phase change material layer and the heater layer, and an upper dielectric layer is formed on the phase change material layer opposite to the lower dielectric layer; and
in formation of the laminate portions, each of the laminate portions further includes:
a lower dielectric portion which is formed by patterning the lower dielectric layer and which is disposed between the phase change material portion and a corresponding one of the heater portions, and
an upper dielectric portion which is formed by patterning the upper dielectric layer and which is disposed on the phase change material portion opposite to the lower dielectric portion.

15. The method as claimed in claim 9, further comprising, before formation of the heater layer, forming a plurality of bottom electrode vias on the semiconductor substrate, such that at least one of the bottom electrode vias is connected to a corresponding one of the heater portions.

16. A method for manufacturing a semiconductor device, comprising:
forming a heater layer on a semiconductor substrate;
forming a phase change material layer on the heater layer opposite to the semiconductor substrate;
forming an upper dielectric layer on the phase change material layer opposite to the heater layer;
patterning the upper dielectric layer and the phase change material layer to form a plurality of upper dielectric portions and a plurality of phase change material portions disposed below the upper dielectric portions, respectively;
forming a spacer material layer to conformally cover the upper dielectric portions and the phase change material portions;
removing portions of the spacer material layer to form a plurality of pairs of spacers, each of the pairs of the spacers laterally covering a corresponding one of the upper dielectric portions and a corresponding one of the phase change material portions; and
patterning the heater layer to form a plurality of heater portions, each of the heater portions being disposed below a corresponding one of the phase change material portions opposite to a corresponding one of the upper dielectric portions.

17. The method as claimed in claim 16, further comprising, before formation of the phase change material layer, forming a lower dielectric layer on the heater layer such that the lower dielectric layer is disposed between the heater layer and the phase change material layer.

18. The method as claimed in claim 17, further comprising, after formation of the spacers and before formation of the heater portions, patterning the lower dielectric layer to form a plurality of lower dielectric portions, such that each of the pairs of the spacers is disposed on a corresponding one of the lower dielectric portions opposite to a corresponding one of the heater portions.

19. The method as claimed in claim 17, further comprising, before formation of the spacers, patterning the lower dielectric layer to form a plurality of lower dielectric portions, such that each of the pairs of the spacers is disposed on a corresponding one of the heater portions and further laterally covers a corresponding one of the lower dielectric portions.

20. The method as claimed in claim 16, further comprising, before formation of the heater layer, forming a plurality of bottom electrode vias on the semiconductor substrate, such that at least one of the bottom electrode vias is connected to a corresponding one of the heater portions.
